(19) United States
(12) Patent Application Publication
(10) Pub. No.: US 2010/0108928 A1
(43) Pub. Date: May 6, 2010

(54) Device for Opening/Closing Valves

(76) Inventor: Juha Solantie, Helsinki (FI)

Correspondence Address: EMERGING STRATEGIES, LLP, 7416 LYNNHURST STREET, CHEVY CHASE, MD, 20815-3102, US

(21) Appl. No.: 12/513,385

(22) PCT Filed: Nov. 6, 2007
(86) PCT No.: PCT/FI2007/000266

§ 371 Date: May 4, 2009

(30) Foreign Application Priority Data
Nov. 7, 2006 (FI) 20060977

(51) Int. Cl. F16K 31/44

(52) U.S. Cl. 251/213

(57) ABSTRACT

The invention relates to a compressed-air driven device for opening and closing valves or similar, by using for this purpose a device (1), to be connected to the valve and creating a rotating motion, in which there is a rotated drive wheel (14) with several retracting pins (15). The pins (15) are arranged in collar-like components (13), into which they can retract when they strike an obstacle.

The present invention relates to a device for opening or closing valves or similar.

Manually-operated valves are of very many different types and very many size classes. The smallest control very small flows, whereas in various production plants really massive valves are used, the operation of which demands work requiring great strength, especially if the valves are used relatively infrequently, or the process conditions are such that they may jam shut, and they cannot be closed/opened easily with the strength of one man.

In larger production plants, there may be hundreds of valves, so that it is easy to understand that during extensive operations there is a great deal of work in closing and opening valves. Particularly if valves are only used, for example, during annual service or longer breaks in production, there may be, numerous valves that have jammed shut and therefore require a great deal of extra work. Turning the valve is work demanding physical strength, but it is also work associated with a considerable risk of causing various stress injuries etc. Strong torsional movements often lead to sprains of some degree and similar injuries. In addition, these operations take much time, which is away from productive work.

A quite common valve construction is a so-called slide valve, in which the rotation of a handwheel causes the valve spindle to rise and fall, when the slide attached to it correspondingly opens and closes the flow channel. Between the spindle and the handwheel there is a threaded joint, through which a linear movement is transmitted to the spindle when the handwheel is rotated.

In large valves, the diameter of the handwheel can be in the order of even a metre. While this of course provides plenty of force for the rotation, nevertheless the force is often too little to perform the work smoothly and correspondingly the work takes place more slowly.

In the art, some attempts to use motor-powered tools to open/close valves are known. For example, a device is known, in which a counter-piece, through which rotation takes place, is fitted specifically and permanently to each valve. One known alternative uses a power drill or similar external additional device as an aid to rotation. It is obvious that in large plants there are numerous different types of valves. In order for there to be a suitable specific drive head for all the valves used, these would have to be many in number, and their permanent installation in each valve or changing them from one valve to another, and particularly carrying a large arsenal of them, would in practice cause very great difficulties.

The present invention is intended to create a device for opening/closing valves, the suitability of which device for different types of valve is ensured and which can be used where suitable operating power, particularly compressed air can be found. The construction of the device according to the invention is designed to take account of both usability and work safety. At the same time, the device is nevertheless simple and economical to manufacture.

The aforementioned and other benefits and advantages of the present invention are achieved in the manner described as characteristic in the accompanying Claims.

In the following, the invention is examined in greater detail with reference to the accompanied drawings, which show one well-regarded embodiment of the invention.

Thus:

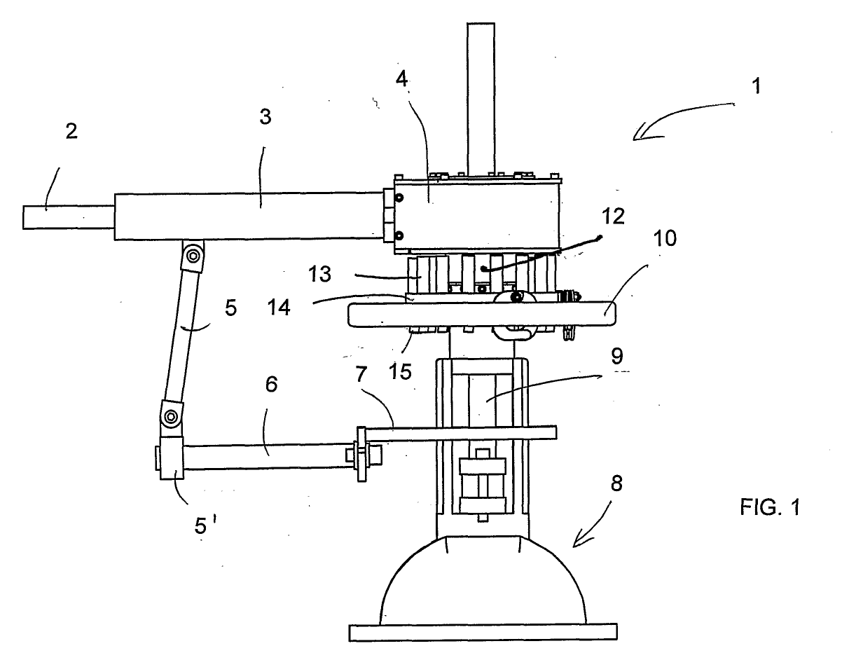

FIG. 1 shows a direct side view of the device according to the invention and

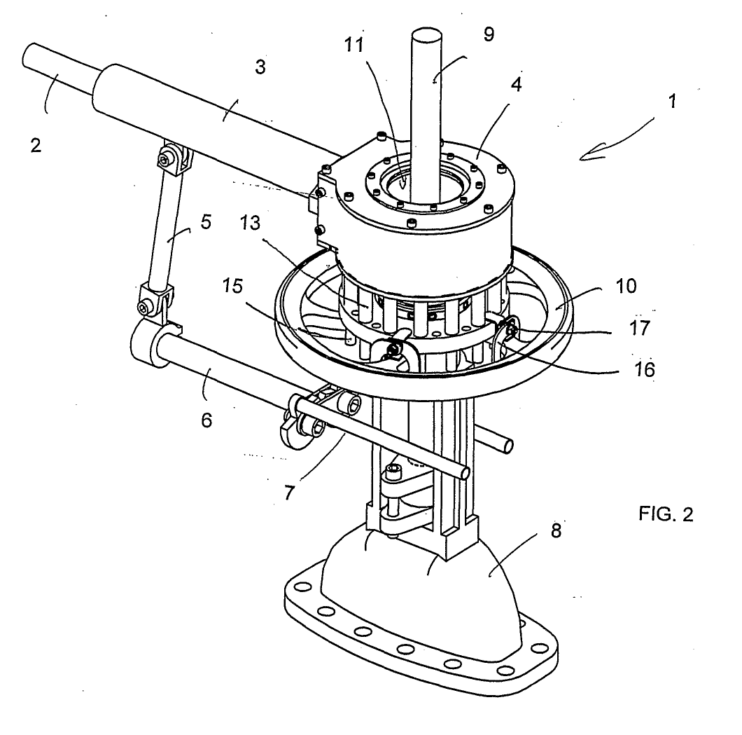

FIG. 2 shows the same device seen at an angle.

The figures, which can be examined in parallel for better illustration, thus show one embodiment of the invention, which is naturally only an example of several embodiments according to the inventive idea coming within the scope of protection of the invention. In FIGS. 1 and 2 the device is in the working position connected to a valve, in order to close/open it.

Thus, the main components of the device 1 are the following: An inlet connection 2 to bring operating power, mainly compressed air, to the device 1. On the other hand, instead of an inlet connection, there could be, for example, an electrical connection for operating the device with the aid of an electric motor. In order to facilitate handling, the device can typically include an arm component 3 of a suitable length. A suitable operating switch is located in a practical place, especially in connection with the arm 3. The actual torsion head is marked with the reference number 4.

If necessary, arms 5 and 6 are used in the device according to the invention, of which at the end of the latter there is an attachment element 7, which is set to rest on the valve body, in such a way that the valve body supports it between or around its components. In the best case, the distance between the components of the attachment element can be adjusted to be suitable for different constructions and can be locked in their positions. The arm 6 is preferably of an adjustable length, for example, in such a way that the arm 6 runs through a loop or eye 5′ at the end of the arm 5 in such a way that it slides and can be locked in the desired position. It is obvious that there is a numerous group of adjustable arm constructions, so that the most appropriate of them is selected for use in connection with the invention. By means of this arrangement, manual control of the torsional forces is unnecessary, though when handling valves in normal conditions, which they do not jam badly, use of this arrangement is not needed.

The operating power, for example a pressure medium, is brought from the connector 2 to the motor or similar creating a rotation motion in the torsion head 4, and which produces torque, which is transmitted to the shaft of the torsion head. Rotation takes place alternatively clockwise or counter-clockwise, depending on whether it is wished to use the device for opening or closing.

The valve itself can be formed of a valve body 8, a valve spindle 9, and a handwheel 10. Depending on the type of valve, the structures can vary a great deal, the problems described above being particularly caused by variations in the construction of the handwheel. In the handwheel 10 there can be two or more spokes, the shape of which can vary, so that according to the present invention the intention is to create a device model that will fit all constructions. Because, as shown in the figures, the spindle 9 often rises above the handwheel 10 when opening, the device must adapt to this construction too. The valve as such naturally does not belong to the scope of protection of the present invention.

The torsion head 4 is formed of a body and a rotating totality mounted on it by bearings, which is operated by the operating force transmitted to it from the drive machine. The actual rotation mechanism is not described in greater detail here, because rotating pneumatic tools, for example, embody entirely conventional technology. Most usually the rotational mechanisms are based on interlocking gear wheels. In fact, the torsion head is ring-shaped, so that the valve spindle 9 can be fitted through the opening 11 remaining in the centre of the torsion head 4. The opening 11 is sufficiently wide for any spindle 9 whatever in normal use to fit through it freely.

In this embodiment, a hollow shaft 12, to which is connected an essentially discoid component 14 with a hole concentric with the shaft and which hereinafter is referred to an the drive wheel, runs through the torsion head 4. A desired number of collars 13 are, in turn, attached to the upper side of the discoid component 14. Pins 15, which are made to protrude from inside the collars 13 particularly by spring loading, protrude from the plane of the undersurface of the disc 14. When an inwards pressing force acts on the pins 15, they retract inside the collars 13 against the spring force. The collar-pin combinations 13, 15 rotate along with the discoid drive wheel 14, when the shaft 12 rotates it.

With the aid of the pins 15, a situation is created, in which the device according to the invention fits any spoke distribution whatever that may be in the handwheel 10. The pins that coincide with the spokes of the handwheel retract. However, those that coincide with a free space remain protruding and can press against the spoke of the handwheel to receive the lateral torsional forces acting on them during rotation. The pins 15 are further supported in the direction of the torsional force on the drive wheel 14, penetrating its openings.

Reference number 16 in the figures marks the means, with the aid of which it is ensured that the device according to the invention remains in place, in such a way that the forks, pivoted at one end around a pivot pin 17, place their ends around the spoke, thus preventing the device from lifting off the during operation. Preferably the forks of the means 16 operate together, in which case they rotate around the pivot pin 17 in a symmetrical manner, being connected to each other, typically by gearing. It is also preferable for the means 16 to be attached to the edge of the drive wheel 14 in such a way that they can be slid along the outer edge of the disc to the desired position, which ensures that the means 16 can be moved precisely to the location of a spoke of the hand wheel of the valve and locked around it. The number of the means 16 can be selected as desired, generally they are a few. The means 16 can also be constructed to be detachable and to only be set in place when required.

If necessary, the components 16 can be locked to the ring, in which case they can also be used in addition to/in place of the pins to receive the torsional force.

There is a desired number, in any event several, of collars 13/pins 15. The device also operates excellently as a general-purpose device, for example, with roughly the pin density shown in the figures. The number is chosen according to the application if the device is made for a specific application, in which the type of valve is known.

As stated above, the components for improving the control of the total device 1, which are marked in the figures with the reference numbers 5, 6 and 7, are optional. They are only one example of the means that can be used, if such are needed at all. There are other alternatives too. The same also applies to the means 16.

In practice, the operation of the embodiment is as follows. The device is connected by a suitable connector, for example, to a network supplying compressed aid, or in the case of an electrically powered device to the electricity network. The torsion head 4 is slid around the valve spindle 9 and the device laid against the handwheel 10. The pins 15 coinciding with the spokes of the handwheel then retract while the others settle into the spaces between the spokes. The means 16 are attached if necessary, as are the support arms 5, 6 and 7. The direction of rotation of the device is selected, i.e. the valve closing or opening direction and rotation is started for as long as needed to achieve the desired degree of opening or closing. After this, the device is detached from the valve.

Though above reference is only made to valves, it will be self-evident to one versed in the art that a device according to the invention can also be used for other kinds of operation, in which a rotating motion plays an important part.

In relation to valves, it can be further stated that the device according to the invention is also highly suitable for opening and closing valves, in which the spindle does not rise above the plane of the torsion wheel, but, as stated, the invention particularly permits the opening and closing of valves, in which the spindle rises above the torsion wheel. It should be further stated that the diameter of the drive wheel 14 and also the location and the number of the pin/collar combinations 13, 15 on the drive wheel are defined case-specifically, but in the basic construction preferably in such a way that the construction will suit most valve constructions.

Other variations, which are not separately mentioned, but which remain within the scope of protection of the inventive idea and the accompanying claims, are possible. For instance the pins 15 may be in a retracted condition inside the collar-like components 13, wherefrom they can be pushed out for connecting into the handwheel 10 of the valve for instance pneumatically. Those pins which are located just above the spokes of the handwheel cannot, naturally, be pushed out and they remain inside the collar-like components. Those pins, on the other hand, which are located between the spokes will be pushed out. It is also possible that the pins can be retracted for instance pneumatically after the use.

1. Device for opening and closing a valve including a torsion head having a rotatable drive wheel configured to be connectable with a handwheel comprising several pins configured to be movable inwardly/outwardly relative to the drive wheel.

2. Device according to claim 1, wherein said pins are taken through the drive wheel.

3. Device according to claim 1, wherein said pins are arranged in collar-like components into which they can retract against a mechanical or pneumatic force when they strike an obstacle.

4. Device according to claim 1, wherein said pins are arranged in collar-like components from which they can be pushed out.

5. Device according to claim 3, wherein said collar-like components are attached to the drive wheel at essentially right angles to a rotational plane thereof.

6. Device according to claim 1, further comprising an auxiliary arm interposed between said device and the valve and configured to provide support against torsion force.

7. Device according to claim 1, wherein the torsion head, a shaft component starting therefrom, and the drive wheel have a central opening to allow the passage of a spindle of the valve.

8. Device according to claim 1, further comprising attachment means configured to be connectable with the drive wheel and a spoke of the hand wheel.

9. Device according to claim 8, wherein said attachment means are configured to be slid along a circumference of the drive wheel.

10. Device according to claim 8, wherein said attachment means is configured to be locked in place, in order to receive forces.

11. Device according to claim 1, wherein said device is powered by compressed air and/or its direction of rotation can be changed.

12. Device according to claim 4, wherein said collar-like components are attached to the drive wheel at essentially right angles to a rotational plane thereof.
